(19) United States
(12) Patent Application Publication
(10) Pub. No.: US 2018/0250642 A1
(43) Pub. Date: Sep. 6, 2018

(54) METHOD FOR AERATING A WINE PRIOR TO TASTING SAME, AND ASSOCIATED DEVICE

(71) Applicant: Michaël Paetzold, La Brede (FR)

(72) Inventor: Michaël Paetzold, La Brede (FR)

(21) Appl. No.: 15/896,360

(22) Filed: Feb. 14, 2018

Related U.S. Application Data
(63) Continuation of application No. 14/784,800, filed on Oct. 15, 2015, now abandoned.

(51) Int. Cl. B01F 3/04; C12H 1/16; B65D 39/00; C12H 1/14; B65D 81/20

(52) U.S. Cl. CPC B01F 3/04794; C12H 1/16; B01F 2215/0072; C12H 1/14; B65D 81/20; B65D 39/00

(57) ABSTRACT

Disclosed is a method for aerating a wine prior to tasting same, the wine being contained in a bottle comprising a neck sealed by a cork. The method involves, after removal of the cork, bringing the wine into contact with a volume of air for a period before tasting it, the volume of air being defined as that required for the wine to open up, which depends on the properties of the wine, closing the bottle again so as to isolate the wine and the defined volume of air from the outside, homogenizing the content of the bottle, and waiting for a defined period P0′ prior to tasting same.

This invention relates to the field of the tasting of wines and more particularly to a method for aerating a wine prior to tasting it. It also relates to a device that makes it possible to use this method.

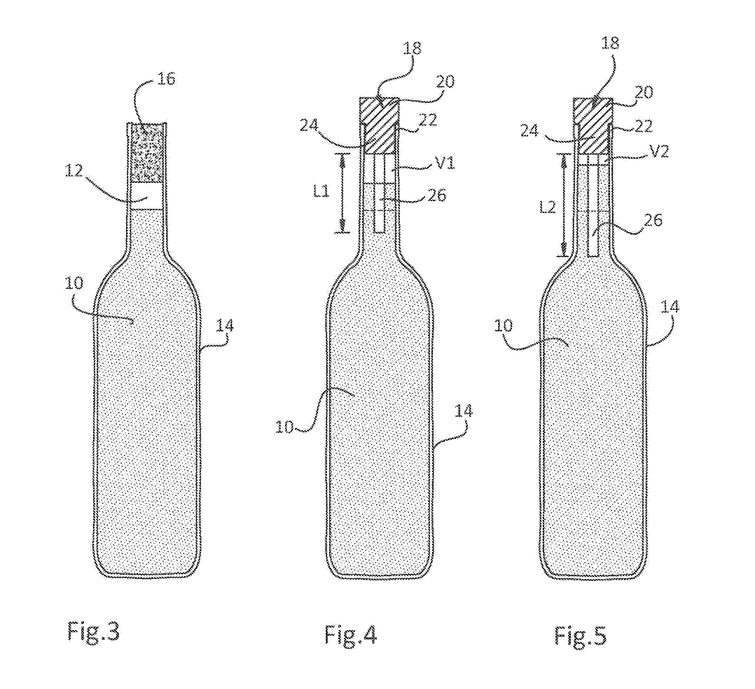

After the winemaking phase, the wine is generally stored in a bottle closed by a cork. Thus, as illustrated in FIG. 3, a certain volume of wine 10 and a slight volume of air 12 are enclosed in the bottle 14.

After bottling, the wine changes very slowly by being in contact with a minute amount of oxygen, that contained in the volume of air 12, and that subsequently introduced through the gas exchange allowed by the slight porosity of the cork 16.

After opening, the wine is in contact with the ambient air and experiences a sudden and substantial introduction of oxygen.

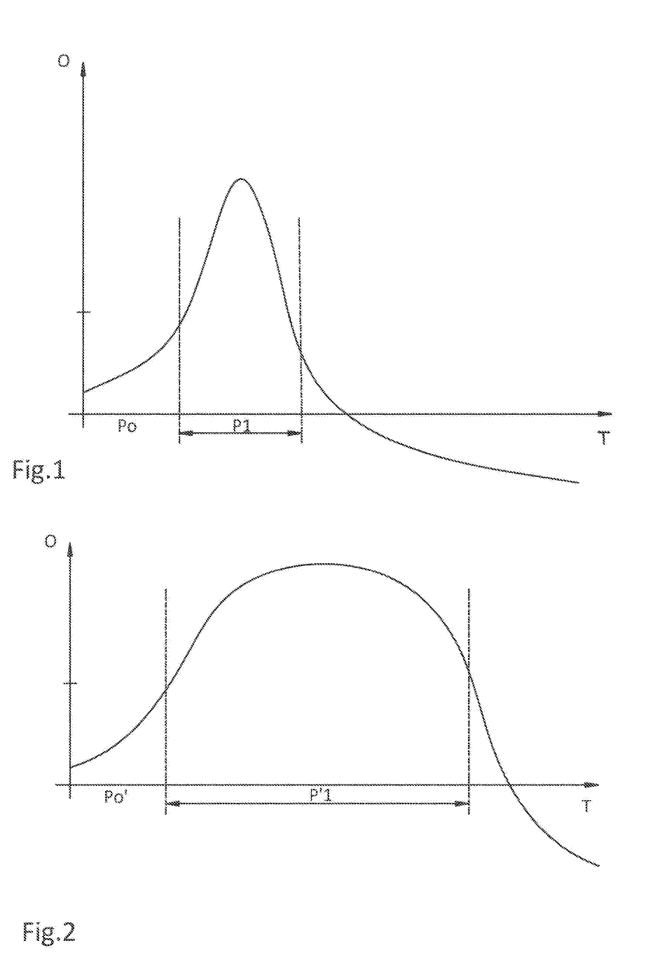

Generally, the change in the wine follows a curve as illustrated in FIG. 1 that shows the oxidation of the wine as a function of time after it is opened.

During a first phase, this supply is beneficial and improves the organoleptic qualities of the wine until reaching a maximum. After a while, the organoleptic qualities of the wine gradually degrade.

Thus, for a phase P0, it is said that the wine opens up. This phase is followed by the phase that is favorable for tasting P1. Beyond this phase P1, also called the tasting window, the wine is not in an optimal state for tasting and gradually loses its gustatory and aromatic characteristics.

Depending on the age, the type (red/white), the fragility and other characteristics of the wine, the phases P0 and P1 are longer or shorter. Thus, the phase P0 can vary in a range from 5 minutes to 1 to 2 hours. The tasting window P1 generally has a short duration from 1 minute to 2 hours.

Considering the value of certain wines, it is important to control this opening-up phase that consists in aerating the wine to optimize its organoleptic qualities and to be able to appreciate it properly.

To aerate a wine, one solution can consist in putting it in a carafe. Thus, the wine is decanted in a carafe having a given volume that is greater than the contents of the bottle. Thus, in the carafe, the wine is put into contact with a given volume of air depending on the volume of the carafe.

According to a first drawback, a carafe does not allow a controlled introduction. In most cases, the wine will, in the carafe, be put into contact with too large an amount of oxygen that will certainly allow it to very quickly reach the phase P1 but also very quickly initiate a phase P2 during which the organoleptic qualities of the wine will gradually be degraded. Thus, by using a carafe to oxygenate the wine, the phase P1 will be considerably shortened, which will increase the difficulty for the consumer to capture it.

According to another drawback, the carafe does not make it possible to determine the time of the phase P0 that is necessary for the wine to open up, nor the tasting window P1.

By experience, a connoisseur can determine the time of the phase P0 that is necessary for the wine to open up and the optimal tasting window.

However, this experience takes a long time to acquire, so there is a need for less experienced individuals to evaluate the appropriate time for tasting.

An alternative to this experience consists in tasting the wine at regular intervals to check on its change. However, this solution is not optimal since it can be necessary to taste the wine a large number of times before reaching the tasting phase.

According to another drawback, the volume of air in contact with the wine in the carafe can be too much and can lead to eroding the organoleptic qualities of the wine.

Also, this invention aims to remedy the drawbacks of the prior art by proposing a method to aerate a wine that can be used by an individual, even one not experienced, to optimize tasting it.

For this purpose, the invention has as its object a method for aeration of a wine prior to its tasting, said wine being contained in a bottle having a neck closed by a cork, said method consisting, after the withdrawal of the cork, in putting the wine into contact with a volume of air for a time before tasting it, characterized in that it consists in determining a volume of air that is necessary for the wine to open up depending on its properties, in reclosing the bottle so as to isolate the wine and the determined volume of air from the outside, in homogenizing the contents of the bottle, and in waiting a determined time P0′ prior to tasting it.

The invention also proposes a device for using the process that is characterized in that it comprises at least one dip rod with, on the one hand, a first part called head which is able to cooperate with a neck of a bottle limiting the transfer of gas between the outside and the inside of the bottle, and, on the other hand, a second part called body whose dimensions are smaller than the cross-section of the neck so as to make it possible for said body to be introduced inside the bottle in the area of the neck under the head, said body having a suitable volume depending on a volume of air necessary for the wine to open up as a function of its properties.

Finally, the invention also proposes a kit having a plurality of dip rods, each having an extension from the body that varies in length from one dip rod to another.

Other characteristics and advantages will come out from the following description of the invention, a description given solely by way of example, with reference to the accompanying drawings in which:

FIG. 1 is a curve illustrating the oxidation of the wine as a function of time after its opening using an aeration method of the prior art,

FIG. 2 is a curve illustrating the oxidation of the wine as a function of time after its opening using an aeration method according to the invention,

FIG. 3 is a cutaway view illustrating a corked bottle of wine,

FIG. 4 is a cutaway view of a bottle of wine equipped with a first dip rod according to the invention after the uncorking,

FIG. 5 is a cutaway view of a bottle of wine equipped with another dip rod according to the invention after the uncorking,

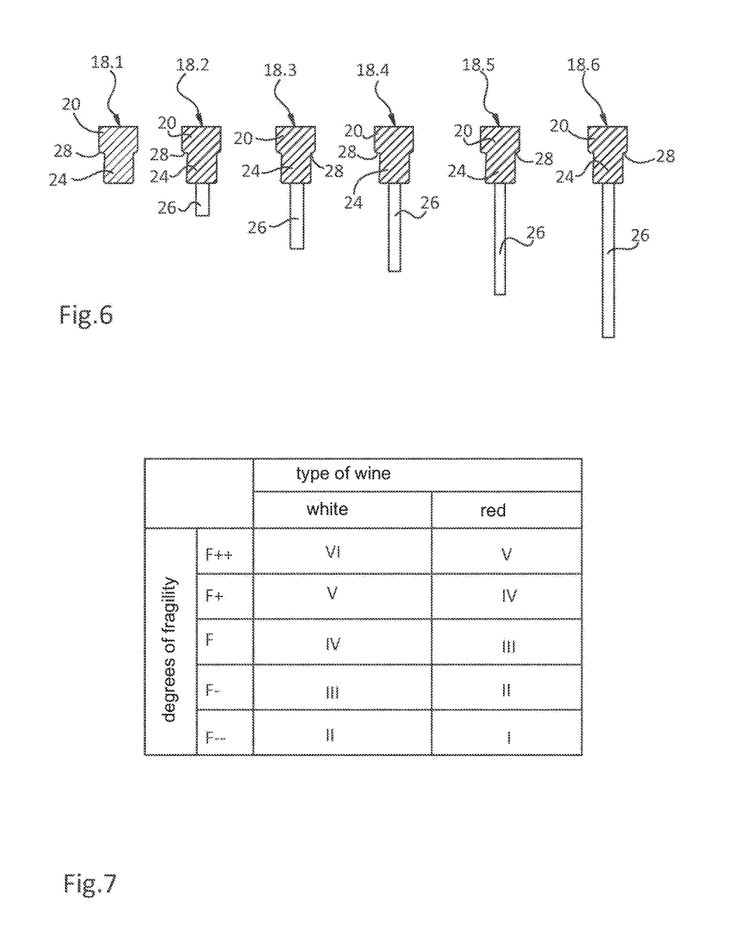

FIG. 6 is a representation of a kit of dip rods according to the invention,

FIG. 7 is a table for determining the dip rod that is suitable for the uncorked wine,

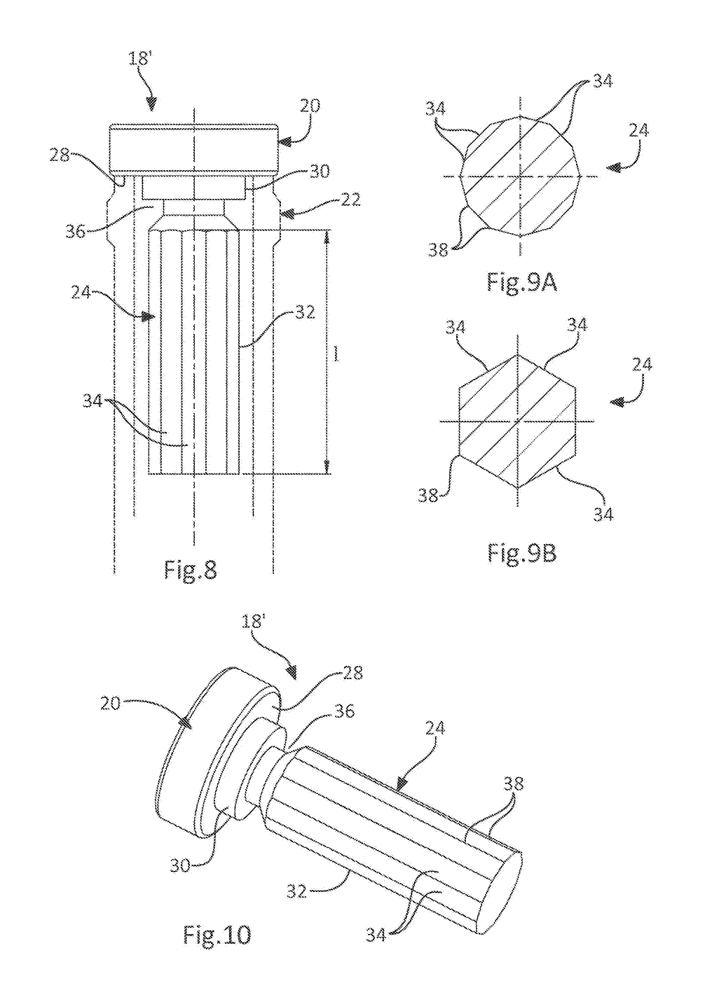

FIG. 8 is an elevation view of a dip rod according to one embodiment,

FIG. 9A is a cross-section of a dip rod according to a first variant,

FIG. 9B is a cross-section of a dip rod according to another variant, and

FIG. 10 is a perpective view of the dip rod illustrated in FIG. 8.

FIG. 3 shows a bottle 14 containing a certain volume of wine 10 and a slight volume of air 12, plugged by a cork 16.

After the bottle is opened, the wine must be aerated to open up.

In contrast with the prior art that proposes putting all types of wine into contact with the same volume of air and waiting a time P0 to taste the wine that can vary depending on the properties of the wine, the aeration method consists in determining a volume of air necessary for the wine depending on its properties and waiting a determined time P0′, in reclosing the bottle so as to isolate the wine and the determined volume of air from the outside, and in turning the bottle over, preferably several times so as to homogenize the contents of the bottle.

According to another aspect, the invention consists in putting into contact with the wine a slight volume of air on the order of a few milliliters, less than 5 ml. This point makes it possible to obtain a more gradual aeration and thus to increase the time of the tasting window P1′. In addition, it limits the risks of altering the wine.

The invention proposes a table that makes it possible, depending on the properties of the wine, to determine the volume of air to be put into contact with the wine.

According to a simplified mode, which can be used by everyone, this table comprises two entries, a first entry relative to the type of wine, red or white, and a second entry as a function of the fragility of the wine that comprises at least two variables, namely fragile and less fragile, or several variables that are very fragile F++, fragile F+, moderately fragile F, slightly fragile F−, and minimally fragile F−−.

By fragile is meant a wine that comprises a small amount of material to be opened up by oxidation.

Other properties of the wine could be used to determine the volume of air to be put into contact with the wine, such as, for example, age, color, grape variety, provenance, amount of tannin, price, . . . .

According to the invention, the more fragile the wine, the more appropriate it will be to reduce the volume of air in contact with the wine. Thus, for a very fragile red wine, the volume of air in contact with the wine is on the order of several milliliters, preferably on the order of 0.5 ml. Further, having equal fragilities, the volume of air in contact with a red wine will be greater than the volume of air in contact with a white wine.

To use the method for aeration of the wine, the invention also proposes at least one device called dip rod 18 that makes it possible to isolate a certain volume of air in contact with the wine.

Thus, right after the bottle is opened, a dip rod 18 is placed in the area of the neck of the bottle so as to isolate a certain volume of air in contact with the wine, as illustrated in FIGS. 3 and 4, then the bottle is turned over so as to have the neck downward so as to improve the oxygenation and to reach the tasting window P1′.

The volume of oxygen put into contact can be adjusted so as to take into account the volume of wine used for tasting when the bottle is opened.

According to the invention, a dip rod 18 comprises, on the one hand, a first part 20 called head which is able to cooperate with a neck 22 of a bottle limiting the transfer of gas between the outside and the inside of the bottle, and, on the other hand, a second part 24 called body whose dimensions are smaller than the cross-section of the neck so as to make it possible for said body to be introduced inside the bottle in the area of the neck under the barrier formed by the head 20.

From one dip rod to the next, the body 24 has a different volume so that it is possible to regulate the volume of air trapped by the dip rod in contact with the wine by selecting the suitable dip rod 18.

The body 24 can comprise an extension in the form of a rod 26 that can be immersed in the wine so as to reduce the amount of air in contact with the wine.

Thus, when a dip rod 18.1 is placed in the area of the neck of a bottle with a rod 26 of a certain length L1, a volume V1 of air in contact with the wine is trapped, as shown in FIG. 4. When a dip rod 18.2 is placed in the area of the neck with a rod with a length L2 greater than L1, a volume V2 of air that is less than the volume V1 is trapped, as shown in FIG. 5, the level of the wine being higher in FIG. 5 than in FIG. 4.

According to one embodiment, the rod 26 is integral with the body and irremovable. In this case, the kit comprises several dip rods 18.1 to 18.6 as shown in FIG. 6, each having a longer or shorter rod 26, optionally the first dip rod 18.1 not having a rod.

According to another embodiment, the rod 26 can be connected to the body 24 in a removable way. In this case, the kit can comprise a single dip rod and several rods of different lengths that can be attached to the body 24 of the dip rod.

According to another embodiment, the connection between the body 24 and the rod 26 allows a relative movement between the rod and the body so as to be able to adjust the length of the rod that is projecting relative to the body. Therefore, the rod can slide or be screwed into the body to adjust its length and the isolated volume of air in contact with the wine.

Different materials can be considered to produce the dip rod. Of course, the parts of the dip rod in contact with the wine must be of so-called “edible” material.

According to a preferred embodiment, the head and the body are made in one piece and appear in the form of a cylinder with a first part forming the head 20 with a first diameter that is greater than that of the neck and a second part forming the body 24 with a diameter that is smaller than that of the first part, adjusted to or slightly less than that of the neck of the bottle.

Thus, the head 20 and the body 24 are delimited by a shoulder 28 that rests against the end of the neck 22, which makes it possible to obtain a precise positioning of the dip rod relative to the neck and a perfect control of the volume of air in contact with the wine.

However, the invention is not limited to this form of dip rod but covers all variants of it. By way of example, the head and the body can be in the shape of a truncated cone.

According to one embodiment, the part of the dip rod in contact with the neck is made of a deformable material so as to ensure a satisfactory fluidtightness between the dip rod and the neck. According to one embodiment, the dip rod can comprise a deformable coating at least in the area of its surface that is in contact with the neck or be made of a material that can be deformed in its entirety.

According to one embodiment, the part of the dip rod in contact with the neck is made of elastomer.

Esthetically, the head 20 can be crowned with a cap (not shown). Advantageously, a device for aerating a wine comprises a kit of dip rods 18.1 to 18.6 or of rods making it possible to isolate a certain volume of air in contact with the wine.

Preferably, to simplify using the method of aeration, the kit also comprises a table shown in FIG. 7 that identifies the dip rod to be used depending on the properties of the wine to be tasted and the duration of the time P0′ to wait before tasting, starting from the moment the bottle is uncorked and the dip rod is put into place in the area of the neck.

Thus, the references I to VI correspond to six different dip rods 18.1 to 18.6 that make it possible to isolate an increasingly reduced volume of air.

Advantageously, the part of the dip rod inserted into the neck and preferably the part able to be immersed in the wine can comprise active elements, namely, for example, elements that make it possible to absorb certain odors.

To improve the aeration, once the dip rod is put into place, the bottle can be turned over so as to orient its neck downward, then straightened back up. During this operation, the user keeps the dip rod in position against the neck by pressing his hand against the dip rod. This operation can be repeated several times.

In FIGS. 8, 9A, 9B and 10, one embodiment of a dip rod 18′ according to the invention has been shown that is placed in the area of a neck 22 of a bottle shown in dot-dash lines.

As before, this dip rod 18′ comprises a head 20 and a body 24. The head 20 appears in the shape of a cylinder with a diameter greater than the inside diameter of the neck.

The body 24 appears in the shape of a more or less long slender element that is approximately coaxial with the head 20, with a cross-section that is smaller than the cross-section of the head 20, suitable for being able to enter the neck 22.

This head 20 comprises a lower surface from which the body 24 extends. The difference in cross-section between the head 20 and the body 24 makes it possible to define a peripheral surface that forms a shoulder 28 that is able to rest against the end of the neck 22. This shoulder 28 can be covered with a flexible material to ensure an enhanced fluidtightness between the dip rod 18′ and the neck 22.

According to this embodiment, the body 24 comprises an upper part 30 connected to the head 20 and a lower part 32 called rod hereafter.

The upper part 30 has a cylindrical shape that is coaxial with the head 20 with a diameter that is smaller than the interior diameter of the neck 22.

The rod 32 has a length 1 that is longer or shorter as a function of the dip rods. According to a variant that is not shown, the rod 32 has a circular cross-section. As a variant, the rod 32 has polygonal cross-sections in transverse planes (perpendicular to the axis of the body 24). Thus, the rod 32 has on its periphery a series of flat sections or facets 34. These facets 34 make it possible to define edges 38 that are parallel to the axis of the body 24. More generally, the body 24 comprises at least one facet 34 that makes it possible to define edges 38 that are parallel to the axis of the body 24. This configuration makes it possible to optimize the homogenization of the wine.

The number of facets 34 can vary from one variant to the next. Thus, according to one embodiment illustrated in FIG. 9A, the rod 32 has twelve sides, which makes it possible to obtain twelve facets 34.

According to another embodiment illustrated in FIG. 9B, the rod 32 has a hexagonal cross-section that makes it possible to obtain six facets 34.

Advantageously, the body 24 comprises a peripheral recess 36 near the head 20. Preferably, the peripheral recess 36 is inserted between the upper part 30 and the rod 32. The base of the peripheral recess 36 forms a restriction of the body 24 and has a cross-section that is smaller than the parts 30 and 32. Thus, the peripheral recess 36 forms a reserve that makes it possible to slow the rate of increase of the upper level of the wine when the dip rod 18′ is introduced into the neck 22 and the body 24 dips into the wine.

This configuration makes it possible to limit the risks of spillover.

1-3. (canceled)

4. A device for aerating a wine contained in a bottle prior to tasting, comprising at least one dip rod (18) that comprises:
a first part (20) configured to cooperate with a neck (22) of the bottle so as to trap a given volume of air, inside the bottle, in contact with the wine,
a second part (24) called a body whose cross-section is smaller than the cross-section of the neck of the bottle so as to allow said body to be introduced into the neck of the bottle, said body (24) comprising a rod (32) having a length adapted to trap the given volume of air inside the bottle and a constant polygonal cross-section,
the rod (32) having at its periphery a succession of identical facets (34), the rod (32) and the facets (34) being dimensioned so that each facet (34) of the rod (32) is separated from an inner wall of the neck (22) when the rod (32) is centrally introduced into the neck (22) of the bottle,
the first part (20) and the second part (24) defining a peripheral surface that forms a shoulder (28) that is able to rest against the end of the neck 22.

5. The device for aerating a wine according to claim 4, wherein the second part (24) comprises a peripheral recess (36), arranged between the first part (20) and the rod (32) said peripheral recess (36) comprising a base having a cross-section that is smaller than the rod (32).

6. The device for aerating a wine according to claim 4, wherein the shoulder (28) is covered with a flexible material to ensure an enhanced fluidtightness between the first part (20) and the neck (22).

7. The device for aerating a wine according to claim 4, wherein the device comprises several dip rods.

8. A method for aerating a wine contained in a bottle prior to tasting, said method comprising the step of:
determining a device for aerating a wine according to claim 4 which has a length adapted for trapping a given volume of air in the bottle according to characteristics of the wine contained in the bottle,
reclosing the bottle with said device for aerating a wine so as to trap the given volume of air,
turning the bottle before tasting.
